(19) United States
(12) Patent Application Publication
(10) Pub. No.: US 2022/0117849 A1
(43) Pub. Date: Apr. 21, 2022

(54) ORAL CAVITY MEDICAMENT DELIVERY DEVICE

(71) Applicant: Manisha Patil-Graziano, Parker, CO (US)

(72) Inventor: Manisha Patil-Graziano, Parker, CO (US)

(21) Appl. No.: 17/431,654

(22) PCT Filed: Feb. 18, 2020
(86) PCT No.: PCT/US2020/018649

§ 371 Date: Aug. 17, 2021

Related U.S. Application Data
(60) Provisional application No. 62/806,969, filed on Feb. 18, 2019.

(51) Int. Cl. A61J 7/00

(52) U.S. Cl. CPC A61J 7/0053

(57) ABSTRACT

A device for oral cavity medicament delivery and/or subject surveillance comprising at least one insertion member and at least delivery member, wherein the delivery member may be impregnated with a medicament agent, may comprise a medicament housing, or may comprise a sensor member for monitoring and/or diagnostic purposes, and a method for using same are disclosed. The device is utilized within a subjects oral cavity to retain medicament agent delivery and/or subject monitoring sensor at a location in the mouth. Upon contact with mucogingival tissue, the delivery member provides immediate and/or persistent medicament agent delivery that may dissipate locally within the oral cavity and/or be absorbed systemically by the subject.

### RELATED APPLICATIONS

This application claims the benefit of priority from U.S. provisional patent application No. 62/806,969, filed on 18 Feb. 2019, the disclosure of which is hereby incorporated by reference in its entirety.

### FIELD OF INVENTION

The invention described in the present disclosure relates generally to the field of oral devices for medicament delivery. More specifically, the disclosure is directed to a device for extended oral delivery of medicaments and/or diagnostic surveillance.

### BACKGROUND OF THE INVENTION

Dental composition and therapeutic dental treatments have been in use for years, usually in gel, paste, foam, or aqueous solution form. Thus, most are intended to be brushed, rinsed or sprayed into the oral cavity or on teeth and last only a few minutes. Many therapeutic treatments require that a medicament or agent be in contact or delivered over a much longer time period. To address some of these needs, various dental trays, strips, and appliances have been employed. However, to date, such efforts have resulted in products that do not perform well, are intrusive or uncomfortable in the oral cavity, or do not encourage subject user compliance.

Extended, persistent, and controlled oral delivery of medicaments, for example, to the gums, buccal, and sublingual areas, has historically been a challenge. Such delivery would offer advantages for localized and/or systemic treatment and dosage. Thus, numerous methods, devices, and configurations, have been attempted, but each has had limitations or setbacks, for example in the areas of comfort, performance, patient compliance, ease of use, etc.

Based on the above, there is a need for a new oral device to provide persistent and prolonged delivery of medicament to and/or monitor a subject in need thereof. Devices that can persistently deliver a medicament for an extended period of time, that can be prefilled or refilled, and are comfortable and easy to use are needed. The invention described in this disclosure solves unmet needs and overcomes shortcomings in the prior art.

### SUMMARY OF THE INVENTION

The invention set forth in this disclosure overcomes the existing drawbacks and prior art by providing for an oral medicament delivery device and methods of use that provide persistent oral delivery of, e.g., medication or lubricants, and may in combination or alternatively monitor a subject. This device provides an effective mode for lubricating dry mouth (a.k.a. xerostomia) or an effective mode for retaining medication with an area of the mouth of a subject for a prolonged period, in particular for therapeutic medicament delivery via sublingual and/or buccal mucosal absorption.

This disclosure provides, in some embodiments, a device useful for passive and persistent delivery of at least one medicament into the oral cavity of a subject. This disclosure further provides, in some embodiments, an oral medicament delivery device that is adaptable for immobilization in multiple positions in the mouth of a subject. In some embodiments, the device may anatomically conform to a subject's mouth.

In some embodiments, this disclosure provides a device for the passive and persistent delivery of medicament in the oral cavity that is adapted to be secured in a selected position within the oral cavity comprising: at least one insertion member and at least one delivery member, and may further comprise at least one connecting member. In some embodiments, the at least one insertion member comprises an elongated compressible shaft having a first end and a second end and a graduated increasing diameter moving from the first end to the second end, wherein the first end is adapted to be inserted into embrasure spaces—the space between two teeth—and the second end is adapted to engage with at least one delivery member, e.g., either directly or via at least one connecting member. Thus, a delivery member may be adapted to engage with the at least one insertion member, wherein the delivery member comprises at least one medicament or at least one sensor, or alternatively houses at least one medicament or at least one sensor.

This disclosure provides, in some embodiments, a medicament delivery device comprising at least one insertion member and at least one delivery member, wherein the delivery member nary be a an impregnated pastille having a disk-like, i.e., flat, thin, profile and may further comprise a connecting member.

This disclosure provides, in some embodiments, a medicament delivery device comprising at least one insertion member and at least one delivery member, wherein the delivery member comprises a semi-permeable or porous housing, and may further comprise a connecting member.

In some embodiments, this disclosure provides a device capable of monitoring a subject via a sensor, e.g., electronically enabled, secured within the oral cavity of a subject. The sensor may, for example, be configured to collect clean, serial samples from a subject. Thus, this disclosure provides, in some embodiments, a medicament delivery device comprising at least one insertion member, at least one delivery member, and at least one sensor. In some embodiments, the sensor may be electronically enabled.

The present disclosure describes an oral medicament delivery device adapted for insertion into the embrasure of a subject, comprising at least one insertion member, and at least one delivery member, and may further comprise at least one connecting member. The at least one delivery member may comprise a biodegradable medicament or a non-biodegradable medicament housing. Alternatively, the at least one delivery member may comprise a sensor.

In some embodiments, the insertion member of the device comprises an elongated compressible shaft having a first end and a second end and graduated and increasing diameter moving from the first end to the second end, wherein the first end is adapted to be inserted into the embrasure of a subject. In some embodiments, the insertion member comprises a slender non-compressible shaft having a tapered first end and broadened second and opposite end, the first end optionally having an overlay.

In some embodiments, the delivery member of the device comprises a non-biodegradable, porous medicament housing, and in some embodiments the delivery member comprises a non-biodegradable, non-porous medicament housing in preferred embodiments of the oral medicament delivery device, the delivery member comprises a non-biodegradable, porous medicament housing and the insertion member comprises a slender shaft having a tapered first end and broadened second and opposite end.

This disclosure further provides methods for passive oral administration of at least one medicament to a subject in need thereof, the method comprising: immobilizing a medicament delivery device into embrasure of the subject, wherein the device comprises at least one insertion member and at least one delivery member.

According to this disclosure, an oral medicament delivery device may be both simple and robust in construction, simple to produce, inexpensive, easy to use, and/or may be reusable or disposable. Broadly, this disclosure contemplates a device orally useful for passive persistent delivery of, e.g., medication and/or lubricant, and further may perform diagnostic sampling and/or monitoring of a subject. When practiced as set forth herein, provided is a novel, effective, oral delivery and/or sensor device, and is, thus, useful as disclosed herein but is not intended to be limited to these uses.

### BRIEF DESCRIPTION OF THE FIGURES

The accompanying drawings are incorporated into and form a part of the specification to illustrate the present disclosure. These drawings, together with the description, explain the principles of the disclosure. The drawings illustrate preferred and alternative examples and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a longitudinal view of an embodiment of the device comprising a compressible insertion member, a filamentous connecting member, and a biodegradable delivery member.

FIG. 2 is a longitudinal view of an embodiment of the device comprising a compressible insertion member, a filamentous connecting member, and a non-biodegradable delivery member.

FIG. 3 is a longitudinal view of an embodiment of the device comprising a compressible insertion member, a filamentous connecting member, and a sensor.

FIG. 4 is a perspective view of an embodiment of the device in use, wherein the insertion member is inserted into the embrasure and the delivery member is positioned abutting the bucco mucosal membrane of a subject. Any or all of the embodiments described herein may be positioned within the oral cavity of a subject as shown in this FIG. 4.

FIGS. 5A-B show an embodiment of the device comprising a non-biodegradable, porous delivery member and an insertion member. FIG. 5A depicts a view of the device wherein the delivery member is closed and the insertion member may be inserted therethrough and into a subject's embrasure; and, FIG. 5B depicts a perspective view of an open delivery member and insertion member of the embodiment.

FIGS. 6A-B shows an embodiment of the device comprising a non-biodegradable deli member having a main housing and a housing closure, where the housing closure comprises at least one formed pore (aperture) there through, and wherein the main housing is integrally combined with at least one insertion member. FIG. 6A depicts a top perspective view of this embodiment of the device; and, FIG. 6B depicts a bottom perspective view of this embodiment of the device.

FIGS. 7A-B show an embodiment of the device comprising a porous, non-biodegradable delivery member, an insertion member, and an optional filamentous connecting member. FIG. 7A is a longitudinal and top perspective view of this embodiment of the device comprising a compressible insertion member; and, FIG. 7B depicts top perspective view of this embodiment of the device comprising a shaft insertion member.

FIGS. 8A-B show longitudinal top perspective views of an embodiment of the device comprising a porous, non-biodegradable delivery member, an insertion member, and an optional filamentous connecting member. FIG. 8A depicts this embodiment comprising a compressible insertion member; and FIG. 8B depicts this embodiment comprising a shaft insertion member.

### DETAILED DESCRIPTION OF THE INVENTION

Reference will now be made in detail to representative embodiments of this disclosure. The embodiments described in this disclosure provide exemplary embodiments only, and are not intended to be exhaustive, limit the scope, applicability or configuration of the devices set forth in this disclosure. Rather, the description of the exemplary embodiments provides those skilled in the art with an enabling description for implementing one or more exemplary embodiments. It is understood by those skilled in the art that various changes, e.g., methods and materials similar or equivalent to those described herein, function and arrangement of elements, which could be used in the practice of this disclosure without departing from the spirit and scope of this disclosure or the appended claims. This disclosure is in no way limited to the methods and materials described.

Unless specifically noted, it is intended that the words, phrases, technical terms, and scientific terms used herein be given the same meaning as commonly understood by those of ordinary skill in the applicable arts. Accordingly, various implementations may be very broadly adopted and applicable. As used herein, all defined terms include analogous terms that those skilled in the art would refer to as analogous or equivalent, or at least partially analogous, or the like.

Throughout this disclosure various patents or publications may be referenced. Each of these publications is hereby incorporated by reference into this disclosure, in their entireties, to the same extent as if each reference were individually and specifically indicated to be incorporated by reference and were set forth in its entirety herein.

The use of the terms “a” and “an” and “the” and similar referents in the context of this disclosure (including in the context of the fa owing claims) is to be construed to cover both the singular and the plural, and thus, is understood to mean, for example, “one or more” and “at least one” which may be used interchangeably. The terms “comprising,” “having,” “including,” and “containing” are to be construed as open-ended terms (i.e., meaning “including, but not limited to,”) unless otherwise noted. It is also to be noted that the terms “comprising”, “including”, and “having” can be used interchangeably. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (“e.g.”, “such as”) provided herein, is intended merely to better illuminate the invention and does not pose a limitation on the scope of the disclosure of invention unless otherwise claimed. No language in the specification should be construed as indicating any non-claimed element as essential to the practice of the invention.

Described herein is an oral medicament delivery device comprising a device capable of being secured in the embrasure space(s) of a subject for the purpose of medicament delivery or subject surveillance and having various features. The device for oral medicament delivery or surveillance is comprised of: an insertion member for immobilizing the device within the oral cavity, preferably a specific position within the oral cavity, and a delivery member comprising at least one medicament and/or housing at least one medicament or surveillance sensor, in combination providing a device that may both persistently deliver medicament for absorption, e.g., via the mucogingival tissue of a subject, and/or monitor a substance or temperature in the oral cavity of a subject. The device may further comprise a connecting member functionally joining the delivery member to the insertion member.

The term “member” as used herein shall be invert its broadest possible interpretation. Accordingly, a description or claim incorporating the term “member” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves. As used herein, the term member includes analogous and partially analogous terminology.

As used herein, the term “medicament” may refer to an agent that comprises an amount, preferably a therapeutically effective amount, of medicine, lubricant, vitamins, nutraceuticals, drugs, breath deodorizers, chemicals, and like compositions that may be administered orally to a subject in need thereof, and optionally one or more acceptable excipients and/or carriers. Medicament may, thus, refer to a single agent, a plurality of individual agents, or a combination or mixture of agents. The turn “medicament” as used herein, thus, broadly includes physiologically and/or pharmacologically active substances for producing a local effect within the oral cavity or a systemic effect within the gastrointestinal tract or body of a subject. As used herein, the terms “medicament” and “drug” each includes analogous and partially analogous terminology. It is envisioned, that the medicaments that may be utilized with the present delivery device may be in the form of, e.g., impregnated pastilles, particles, capsules, microcapsules, beads, granules, or fibers, or may be in another form of a solid mass, e.g., pastille. As used herein, the term medicament includes analogous and partially analogous terminology.

The term “subject” is used herein to referee to any subject, preferably a mammalian subject, and more preferably a human or non-human mammal for whom diagnosis, surveillance, and/or treatment (therapy) is desired. Mammalian subjects include, for example, humans, non-human primates, domestic animals, farm animals, companion animals, and zoo, sports, or pet animals, such as dogs, cats, horses, cattle, cows, and the like. The term “surveillance” may encompass but is not limited to measuring, monitoring, and sampling, e.g., substances, levels of substances, changes in level of substances, and/or temperature of a subject. As used herein, the term surveillance includes analogous and partially analogous terminology.

As used herein, the terms “treat” or “treatment” includes therapeutic or prophylactic treatment. A “therapeutic or prophylactic treatment” comprises prophylactic treatments aimed at the slowing of or complete prevention of clinical and/or pathological manifestations or therapeutic treatment aimed at amelioration or remission of clinical and/or pathological manifestations. The term “treatment” thus also includes the amelioration or prevention. Subjects in need of treatment include those already with a condition or disorder, those prone to have the condition or disorder, or those in which the condition or disorder is to be prevented. As used herein, the terms treat and treatment include analogous and partially analogous terminology.

As used herein, the term “pastille” refers to a pastille, lozenge, tablet, capsule, pill, caplet, drop, ball, or the like, and includes analogous and partially analogous terminology.

As used herein, the term “substance” means a substance capable of being monitored or measured that is produced by, excreted from, or evidenced by a subject, e.g., hormones, blood sugar, electrolytes, immunoglobulins, enzymes, salivary biomarkers or metabolites, bacteria, any analyte that can be affected by physiological and/or pathological conditions, such as, HIV, renal disease, cardiometabolic dysfunction, etc. As used herein, the term substance includes analogous and partially analogous terminology.

As used herein, the term “impregnate” means to soak, expose to, incorporate into, absorb into, adsorb onto, or saturate something, e.g., a pastille, lozenge, or substrate, with an agent or medicament. For example, a pastille or lozenge may be impregnated with an agent or medicament that, e.g., lubricates, numbs, palliates, coats, or treats an indication of a subject. As used herein, the defined term “impregnate” includes those analogous terms that those skilled in the art would refer to as impregnate or impregnated, or by at least partially analogous terms, such as, infuse, soak, steep, saturate, drench, coat, etc., or the like.

### Insertion Member

Broadly, an insertion member of the present disclosure include members in any format intended and useful for securing, anchoring, or immobilizing the devise of the present disclosure in the oral cavity, preferably the embrasure, of a subject. In some embodiments, gel foam or other polymers, for example, polyvinyl chloride (PVC) or polyurethane (PU), may be used for construction of the insertion member because of, e.g., their low cost, light weight, compressibility and rebound aspects, and availability. Myriad alternative construction materials may be employed provided they are compressible or alternatively well suited, i.e., of a certain shape and size, to be inserted in to the space between the teeth of a subject, for example, after insertion may expand, rebound, or reshape to secure the present device at a position within the oral cavity. The term “compressible” is generally accepted to mean the volume of a substance can change when pressure is applied to it, for example, when gel foam is “rolled” between two fingers to achieve compression, and upon release of pressure the material attempts to return to its former gate. Alternatively, in some embodiments, insertion members may be constructed from materials having little or no compressibility aspects, e.g., plastic, nylon.

The insertion member may be constructed from all naturally occurring materials, synthetic materials, or a combination thereof. In some embodiments, the insertion member may be constructed from a combination of compressible and non-compressible material, or may further comprise a sleeve to assist in embrasure insertion or an overlay, e.g., foam, for comfort. It is envisioned that the insertion member is comprised of non-biodegradable materials that may be discarded after use or sterilized and reused. It is also envisioned that in some embodiments the insertion member materials may comprise partially or totally biodegradable material. Production of and selection of suitable construction materials of the insertion member may further include consideration and selection of size, shape, density, rigidity, compression factor, or the like, which may be adjusted to suit the specific use of the device.

The construction material of the insertion member may comprise a single or combination of two or more materials and/or one or more layers, provided the end product insertion member carries appropriate and desired rigidity or rebound ability to be useful as intended. In some embodiments, the construction materials for the insertion member may comprise a closed cell foam, tape, plastic or a synthetic material made from polymers (e.g., polyethylene, PVC, nylon), polyurethane foam, modified gel foam, silicone core with bonded overlay (e.g., foam), closed cell foams coupled with silicone or other cores, or any combination or variation of construction materials, including those that can be molded into a shape while soft and later set into a rigid or slightly elastic form, or any other suitable construction material, each of which is well known in the art and commercially available.

In some embodiments, the insertion member comprises a compressible element adapted for insertion into the embrasure of a subject, e.g., an elongated compressible shaft having a first end and a second end, and graduated and increasing diameter moving from the first end to the second end, wherein the first end is adapted to be inserted into the embrasure of a subject, and the second end is adapted for engaging with a delivery member and/or a connecting member.

In some embodiments, the body of the insertion member comprises a slender shaft that comprises a tapered or pointed first end and a flattened or broadened second and opposite end, wherein the tapered first end may be inserted through an aperture in a delivery member and into the embrasure of a subject to secure the device within the oral cavity. It is envisioned that an insertion member configured as a shaft may be comprised of one, two, or more materials. In some embodiments, the insertion member may be comprised of rigid shaft material having a compressible overlay portion, e.g., on the tapered first end, and/or a shaft sleeve disposed there over.

### Connecting Member

Broadly, a connecting member of the present disclosure include members in any format intended and useful for connecting an insertion member to another element of the device of the present disclosure, preferably the delivery member. In some embodiments, connecting members of the present disclosure flexibly connect an insertion member to a delivery member such that the delivery member may be moved about and comfortably positioned between the cheek and gums of a subject by manipulating the connection member. In some embodiments, a portion, e.g., ⅓ to ½ the length of the connecting member, may be embedded within the body of an insertion member, or optionally, securely attached to the second end of an insertion member. The opposite end and remaining length of the connecting member, thus, extends out from and beyond the second end of the insertion member and may engage with and functionally join a delivery member, for example, by threading through an aperture in a delivery member and looping back onto and connecting with itself, or may be embedded within the body of a delivery member. In some embodiments, the insertion member and connecting member may be a unitary body, integrally combined elements, or detachable elements. For example, an insertion member and connecting member may be a unitary body wherein the connecting member is a part of the insertion member without a foam overlay, i.e., a combination material insertion member comprising an outer compressible material and an internal, malleable material able to articulate, and conform to an area of placement of a connected delivery device within the oral cavity of a subject.

In some embodiments, connecting members are envisioned as filamentous and may be constructed from all naturally occurring materials, synthetic materials, or a combination thereof. It is envisioned that the connecting member is comprised of non-biodegradable materials that may be discarded after use or sterilized and reused. It is also envisioned that the connecting member materials may comprise partially or totally biodegradable material. The connecting member may be constructed from, for example, stainless steel thread or other non-corrosive metal, or alternatively from dental floss or dental tape like materials. The filamentous materials, including, floss, tape, and suture materials are generally commercially available as well as may be fabricated from either natural or synthetic sources, e.g., filaments, yarns, polymer, nylon, rayon, Dacron, acrylic, acetate, polypropylene, polyethylene, and other plastics or polymers now known or known in the future, alone or in combination. Production and selection of suitable construction materials of the connecting member may further include consideration and selection of size, shape, length, density, rigidity, flexibility, tensile strength, or the like, which may be addressed and adjusted to suit the specific use of the device, and is well within the purview of the skilled artisan.

### Delivery Member

Broadly, a delivery member of the present disclosure includes members in any format intended and useful for providing a medicament and/or a discrete location for a medicament to reside in the oral cavity of a subject to facilitate diffusion, absorption, dissolution, or the like, of the medicament. The delivery member may be constructed from all naturally occurring materials, synthetic materials, or a combination thereof, and may comprise a single layer or a plurality of layers. It is envisioned that the delivery member may be non-biodegradable materials that may be discarded after use or sterilized and reused. It is also envisioned that in some embodiments of the delivery member may comprise partially or totally biodegradable material. Production of and selection of suitable materials for the delivery member may further include consideration and selection of size, shape, density, rigidity, porous aspects, or the like, which may be adjusted to suit the specific use of the device, and is well within the purview of the skilled artisan. Thus, delivery members of the present disclosure may comprise a medicament, e.g., a biodegradable impregnated pastille with no housing, or alternatively, a non-biodegradable housing in which a biodegradable medicament is encased, housed, or may be inserted.

In some embodiments, a biodegradable delivery member of this disclosure may be fabricated as an impregnated and dissolvable (biodegradable) pastille. Medicaments useful with the device, e.g., pastille or other form of medicament, may comprise a substrate having one or more medicaments impregnated therein, and/or one or more coatings and/or one or more layers, e.g., to facilitate delayed dissolution within the oral cavity and produce extended, persistent, and/or timed release of an active ingredient or ingredients. Medicaments may additionally or alternatively comprise microencapsulated active ingredient to facilitate extended and persistent release of active ingredient or ingredients impregnated therein. Medicaments may be produced having a predetermined dosage and formulated for immediate release, extended release and/or a combination thereof. Through choice of acceptable and approved substrate material and amount of medicament agent to be delivered, the delivery member may be selectively determined to be of a certain size, weight, shape, etc., well know in the art, and preferably, to be lightweight and easily contained in the oral cavity abutting and resting on mucogingival tissue of a subject.

Delivery members may engage directly with an insertion member or engage with an insertion member via a connecting member, in either case functionally in a manner that may permit them to freely move, be moved, rotate, or be rotated such that the device may be easily manipulated, e.g., in order to conform to the anatomy of Me subject.

In some embodiments, a delivery member is envisioned to comprise a non-biodegradable housing constructed of porous, semi-permeable, or non-porous material within which a medicament or sensor may be encased, housed, or inserted. Such embodiments of the delivery member of the device may be made of porous material, e.g., filter paper, plastic mesh, or non-porous material, e.g., closed cell foam, into which pores are formed. It is envisioned that construction material of the delivery member may be porous, e.g., inherently porous material such as mesh, however, non-porous material into which pores are formed may be employed in the construction of the delivery member. Preferably, the delivery member is comprised of material inherently having a plurality of pores.

The construction material of some embodiments of delivery members may comprise a single or combination of two or more materials, and/or single or multiple layers of materials, and/or synthetic and/or natural materials, provided the end product delivery member carries appropriate and desired aspects to be useful as intended. In some embodiments, construction materials for the delivery member may comprise, e.g., rubber, latex, filter paper, nylon, cotton, natural animal casing, a closed cell resin, plastic, silicone, synthetic materials made from polymers, biodegradable filaments, and the like, or any other suitable construction material, combination or variation of construction materials.

The delivery member of the device allows the saliva of a subject to move through the pores of the delivery member, thus, dissolving the medicament contained therein, after which the medicament may diffuse out of the delivery member housing into the oral cavity of the subject or come in contact with, e.g., a subject's inner cheek or guru, and be absorbed systemically by a subject. Alternatively, the saliva of a subject may move through the porous delivery member housing and a sensor encased therein may perform surveillance actions, e.g., measurements, thereon. Such embodiments of a delivery member may be disposable, i.e., consumable, or reusable, i.e., refillable.

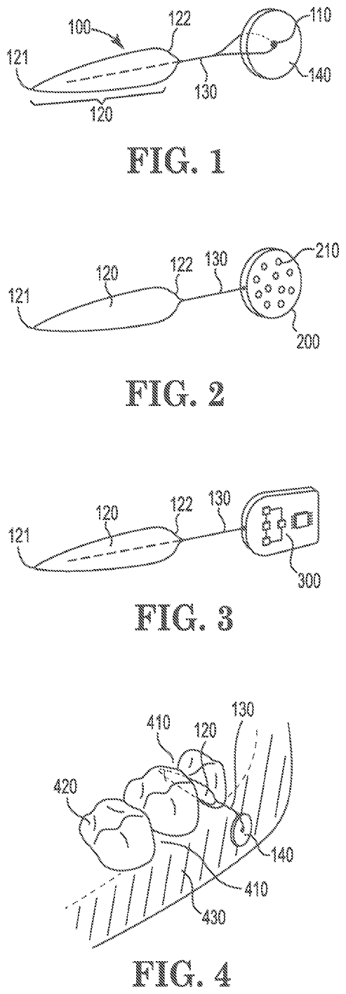

Some medicament delivery members may be reusable, e.g., refillable, and other delivery members may be prefilled and/or disposable. For example, reusable delivery members may comprise folding pouch style housing or a housing having a removable section facilitating refill. Alternatively, disposable porous delivery members may comprise sealed and prefilled porous housing in any shape, e.g., a donut, a rectangle, etc., provided the shape fits comfortably within the oral cavity. It will be recognized that while FIGS. 1 through 8, described, below, illustrate specific shapes of the components of the device, other shapes are possible for the components, e.g., the delivery members described herein may take any number of shapes without effecting their efficacy, such as, sphere, rectangle, square, oval, pouch-shape, crescent, rod-shape, oblong, cylindrical, teardrop, hourglass, half-moon, or any other shape. For example, as shown in FIG. 8, embodiments of the delivery member are depicted as “pillow shaped” but other shapes may be utilized so long as the shapes fit comfortably in a subject's mouth.

A delivery member may be comprised of a single medicament, a combination of two or more medicaments, one or more layers of porous or semi-permeable construction material, a combination of porous and non-porous construction material, and combinations thereof. In some embodiments, a delivery member may be manufactured as profiled with a medicament or sensor, and in some embodiments, the medicament or sensor may be inserted prior to use.

In some embodiments, a delivery member may comprise a sensor, the sensor manually or electronically enabled, for monitoring and/or measuring a subject, e.g., substances, temperature, for surveillance and/or diagnostic purposes. Such sensors are known in the applicable arts and the choice of appropriate sensor(s) for use with the present device is well within the purview of one skilled in the art. For example, a sensor of appropriate size and functionality may be manually engaged, or alternatively remotely controlled and/or monitored. In some embodiments, the delivery member may be a sensor, and in some embodiments the delivery member may encase a sensor. In some embodiments, a delivery member may comprise a combination of at least one medicament and at least one sensor.

A plethora of alternative construction materials and configurations of each of the components of the device, i.e., insertion members, connecting members, and delivery members, is possible by the skilled artisan, some of which may be customized. Each of the components comprising the presently disclosed device may be constructed by, e.g., molding, machining, stamping, casting, cutting, 3D printing, dipping, or other fabrication methods now known or known in the future that would produce components with appropriate attributes, e.g., size, shape, strength, weight. Specific aspects, e.g., size, composition, malleability, permeability, etc., of a device will be ascertainable by one skilled in the art using known techniques and without undue experimentation. Moreover, as is know in the art, determination of and adjustments for specific purpose and use, administration, oral cavity size and configuration, tolerance, etc. may be made. Suitable devices intended for humans may range in size, and may be adjusted accordingly up and/or down for use in non-human mammals, e.g., dogs, horses. For example, embodiments of the device may be sized and configured to comfortably fit inside a subject's mouth, e.g., between the teeth and cheek. Preferably, the delivery member for use with a human subject may range from about 10 mm to about 35 mm long, about 10 mm to about 35 mm wide, and about 3 mm to about 10 mm thick, but the dimensions may be adjusted according to the specific use of the device and/or the specific subject. Preferably, the length of a filamentous connecting member for use with a human subject may range from about 5 mm to about 65 mm long, but the length may be adjusted according to the specific use of the device and/or the specific subject. Preferably, the insertion member for use with a human subject, either compressible or shaft, may range in length from about 5 mm to about 20 mm long, and range from about 2 mm to about 5 mm in diameter, and may be adjusted according to the specific use of the device and/or the specific subject.

### Device

Referring to FIG. 1, an embodiment of the device 100 comprising a compressible insertion member 120, a filamentous connecting member 130, and a biodegradable delivery member 140 is shown. The features of this embodiment of the device 100 comprise an insertion member 120 defined by an elongated compressible shaft having a first end 121, a second end 122, and graduated and increasing diameter moving from the first end 121 to the second end 122, wherein the first end is adapted to be inserted into the embrasure of a subject. Extending outwardly from the second end 122 is a filamentous connecting member 130 functionally joined to a delivery member 140, wherein the delivery member is partially embodied in a pastille or the like.

The first end 121 of the body of the insertion member 120 may be inserted within the embrasure of a subject (see FIG. 4) to immobilize the device 100 within the oral cavity of a subject.

As shown in FIG. 2, an embodiment of the device comprising a compressible insertion member 120, a filamentous connecting member 130, and a non-biodegradable delivery member 200 is depicted. The insertion member and connecting member in FIG. 2 may be constructed as in FIG, 1, and as shown in this embodiment of a delivery member 200, a housing haying a plurality of pores 210 therein is exemplified. The delivery member 200 in this embodiment comprises anon-biodegradable, reusable, and semi-permeable or non-porous housing. A plurality of pores 210 may be formed in the housing, and may be located on one or both sides of the delivery member 200, and may range in size from 1-2 mm, from 2-3 mm, from 3-4 mm, from 4-5 mm, or larger, or smaller, and may be chosen based upon the size of the deliver member and the intended medicament to be housed within. The delivery member 200 may comprise a housing having two halves, e.g., a top and a bottom, that seed integrally one inside the other, or may snap together, or any other known housing format, the production of each is well known to the skilled artisan, thus facilitating the housing of a pastille, non-pastille medicament, or a sensor within its cavity.

FIG. 3 depicts an embodiment of the device comprising a compressible insertion member 120, a filamentous connecting member 130, and a sensor 300. As shown in FIG. 3, a separate housing encasing the, e.g., electronic, sensor delivery member 300, as shown in FIG. 2, may be unnecessary. In this embodiment, the delivery member 300 engages directly with the connecting member 130 of the device 100. In some embodiments, the insertion member 120 may engage directly with the delivery member 300. The direct engagement of the insertion member 120 with a delivery member may be similarly employed with the delivery members 140, 200, as shown ire FIGS. 1 and 2.

In use, the insertion member of the embodiments of the present device is inserted into the embrasure of a subject. By was of example, FIG. 4 shows a perspective view of an embodiment of the device in use, wherein the insertion member 120 is inserted into the embrasure 410 and the connecting member 130 is manipulated such that the delivery member 140 is positioned abutting the bucco mucosal membrane 430 of a subject. Any or all of the embodiments described in this disclosure may be immobilized within the oral cavity of a subject as shown in this FIG. 4, i.e., via insertion into embrasure of a subject.

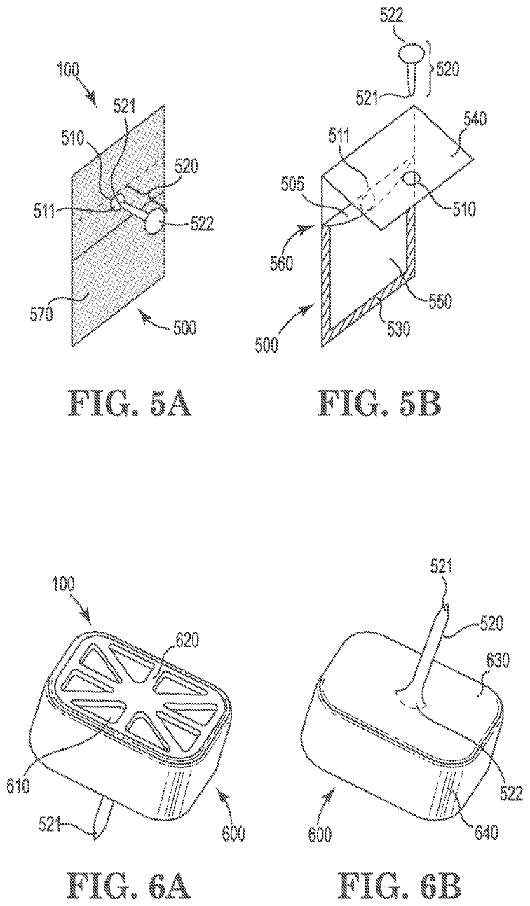

In a preferred embodiment of the device 100, a delivery member 500 directly engages and removably couples with an insertion member 520 as depicted in FIGS. 5A and 5B. Broadly, this embodiment comprises a pouch shaped, porous delivery member 500 having a defined housing compartment, and may include a one or more sheets of porous material.

This embodiment of the medicament delivery device comprises a folding pouch style housing 500 comprising a front panel 550 and a back panel 560, wherein the front panel 550 is shorter in length than the back panel 560 and aligned and affixed, e.g., sealed, to a terminal end of the back panel 560, creating a cavity there between into which medicament may be inserted through an opening 505. The opposite terminal end of the back panel 560 forms a top closure 540 that folds over the front panel 550 to close the delivery member 500. A pair of apertures 510, 511 in the top closure 540 and back panel 560, respectively, are positioned to align and receive an insertion member 520 there through. The apertures 510, 511 as well as the fold for the top closure 540 may be adjusted according to the size and shape of the delivery member 500. The delivery member 500 of the preferred embodiment, thus, having at least a front panel 550, a back panel 560 having an aperture 511 there through, a back panel top flap 540 having an aperture 510 therethrough that aligns upon folding with the aperture 511 in the back panel 560, an affixing seal 530 joining the front panel 550 to the back panel 560, thereby defining a housing compartment and an opening 505 through which the housing compartment may be accessed. The delivery member 500 of this embodiment haying a plurality of pores 570, and preferably pores that are inherent in the material used to form the delivery member 500. In other embodiments, the plurality of pores may be formed in the delivery member. Dependent upon the construction material of the delivery member, sealing may be accomplished by any suitable sealing method or combination of methods to create the seal 530, e.g., adhesive, thermal, sonic, woven, or another method of sealing porous or non-porous material known or yet to be known in the art. Seals may comprise internal seals, external seals, or a combination thereof. Alternatively, folding rather than or in combination with sealing may be employed on 1, 2, or 3 sides of the delivery member 500.

FIGS. 5A-B show a preferred embodiment of the device comprising a reusable and refillable porous, delivery member 500 and an insertion member 520 comprising a slender shaft having tapered first end 521 and flattened opposite second end 522, wherein the tapered first end 521 may be inserted through the apertures 510, 511 in the delivery member 500 in the closed position and into the embrasure 410 of a subject to secure the device 100 within the oral cavity. FIG. 5A depicts a view of the device 100 wherein the delivery member 500 is in a closed and folded position with an engaged insertion member 520. In this preferred embodiment, the insertion member 520 comprises a slender shaft that comprises a tapered or pointed first end 521 and flattened or broadened opposite second end 522, wherein the tapered first end 521 is inserted through an aperture in the delivery member 500 and into the embrasure 410 of a subject to secure the device within the oral cavity. However, alternative configurations of the insertion member for use with this embodiment, e.g., elongated compressible shaft insertion members as described herein are envisioned and fall within the scope of this disclosure.

In some embodiments, FIG. 6, the medicament delivery member 600 of the device may comprise reusable, refillable, non-porous delivery member having a housing defining a cavity into which medicaments may be inserted, and a closure cover haying at least one pore, and preferably a plurality of pores, formed therein, through which saliva and medicament may interact. The delivery member of this embodiment of the device 100 comprises an open housing defined by single continuous wall 640, the wall 640 contiguous with a floor 630, a removable closure cover 620 that is sized and adapted to seed inside the top lip of the wall 640, and an integrally combined shaft insertion member 520 extending outward from the outside wall of the floor 630 of the housing at an angle ranging from 45-135° in relation to the floor 630, and preferably between 80-110°, as shown in FIGS. 6A-8. This embodiment of delivery member 600 with integrally combined insertion member 520 extending outward therefrom and removable cover 620 having at least one pore 610, and preferably a plurality of pores, formed therein may house a medicament and/or sensor, wherein the subject's saliva is able to move freely through the at least one pore 610 and engage therewith. In use, the removable cover 620 may be removed, medicament inserted within the cavity of the delivery member 600, the cap 620 replaced, and the insertion member 520 inserted into the embrasure of a subject.

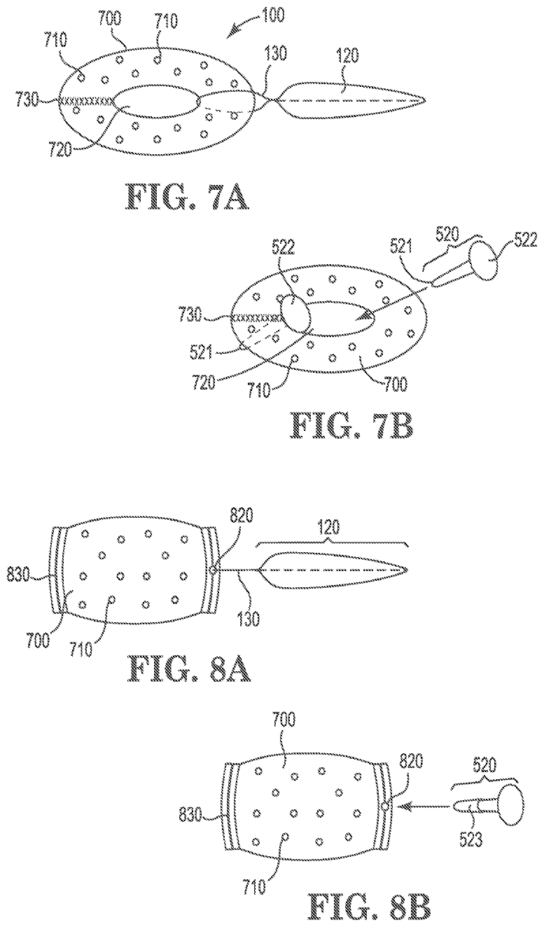

In some embodiments, FIGS. 7A-B and FIGS. 8A-B, disposable, prefilled, medicament delivery devices comprising a compressible insertion member 120 and a non-biodegradable, disposable delivery member 700 (FIGS. 7B and 8B) are depicted, and devices further comprising a filamentous connection member 130 are depicted in FIGS. 7A and 8A. The insertion member 120 and connecting member 130 may be configured as previously described. The delivery member 700 comprises a portion of non-biodegradable, porous or non-porous, tubular casing having a first and second end, and into which medicament is inserted prior to sealing the delivery member. Porous or non-porous construction material of the delivery member 700 may further comprise additional pores 710 to facilitate dispersal of medicament into the oral cavity of a subject. The plurality of pores 710 may be located on a select section or sections of the delivery member 700, or alternatively, over the full surface of the delivery member 700, and may range in size as previously disclosed. FIG. 7A shows a delivery member 700 configured in a “donut” shape, wherein after the insertion of a medicament into the cavity of the casing, the first and second end of the portion of tubular casing are affixed one to the other, i.e., sealed 730. As described previously, a connecting member 130 and an insertion member 120 are functionally engaged with the delivery member, wherein the insertion member 130 is coupled to the delivery member 700 via the connecting member 130. In an alternate embodiment, depicted in FIG. 7B, an insertion member 520 is inserted through the “donut hole” aperture 720 in the delivery member 700 and into a, subject's embrasure to secure the device 100 within the oral cavity.

Dependent upon the construction material of the delivery member embodiments of FIGS. 7A-B, sealing may be accomplished, by any suitable sealing method to create the seal 730, e.g., adhesive, thermal, sonic, woven, or another method of sealing porous or non-porous material known or yet to be known in the art. Seal 730 may comprise an internal seal, external seal, or a combination thereof.

FIG. 8A shows a porous, disposable delivery member 700 comprised of a portion of tubular casing having a first end and a second end, configured in a rectangular “pillow” shape defined by at least one seal 830 on each of the first end and second end, thus defining an internal cavity into which medicament may be inserted prior to sealing, and further comprising an aperture 820, for example, through the first end, the second end, or both ends, through which a connecting member 130 connects an insertion member 120 as previously described to the delivery member 700, FIG.

FIG. 8E depicts an alternate embodiment comprising a delivery member 800 and an insertion member 520 wherein the device 100 is secured within the oral cavity of a subject as previously described. In an additional embodiment of the insertion member 520, the slender shaft may be comprised of rigid shaft material having a compressible overlay 523 disposed on the tapered first end or a shaft sleeve disposed thereon. The porous or non-porous construction material of the delivery member 700 may further comprise additional pores 710 to facilitate dispersal of medicament into the oral cavity of a subject. The plurality of pores 710 may be located on a select section or sections of the delivery member 700, or alternatively, over the full surface of the delivery member 700, and may range in size as previously disclosed.

Dependent upon the construction material of the delivery member embodiments of FIGS. 8A-B, sealing may be accomplished, by any suitable sealing method to create the seal 830, e.g., adhesive, thermal, sonic, woven, or another method of sealing porous or non-porous material known or yet to be known in the art. Seal 830 may comprise an internal seal, external seal, or a combination thereof. Alternatively, folding rather than or in combination with sealing may be employed.

### Use

In use, a shown in FIG. 4, the first end 121 of the insertion member 120 is inserted into the embrasure space 410 between teeth 420 of a subject to secure the device 100 within the oral cavity, allowing the delivering member 140 to be placed and rest against the mucosal 430 of the subject in the cheek vestibule. Alternatively, the first end 521 of the shaft insertion member 520 may be inserted into the embrasure space 410 between teeth 420 of a subject to secure the device 100 within the oral cavity, allowing the delivery member 500 to be place and rest against the mucosal 430 of the subject in the cheek vestibule. For insertion, the first end 121, 521 of an insertion member is compressed if necessary, e.g., with finger pressure, inserted into embrasure, and held in placed to allow decompression (expansion) in order to secure the insertion member 120, 520 in a chosen location within the oral cavity. In some embodiments, no compression or expansion is necessary. The device of the present invention may be used either on the upper or lower jaw of the subject or sublingually provided there is a tooth embrasure into which the insertion member may be inserted to secure the device.

In some embodiments, the medicament will be “used up” after a specific time period and the device discarded. In some embodiments, the medicament may be refilled and the device continuously or periodically used for extended periods. The device 100 may be used, depending upon the medicament, for about 1 minute to about 24 hours, e.g., about 1 minute to about 10 minutes, about 5 minutes to about 20 minutes, about 10 minutes to about 30 minutes, about 15 minutes to about 45 minutes, about 20 minutes to about 55 minutes. about 30 minutes to about 1 hour, about 45 minutes to about 1 hour and 15 minutes, about 1 hour to about 1 hour and 30 minutes or about 1 hour and 30 minutes to about 2 hours, etc. up to 24 hours, or longer, e.g., 1 week, 1 month, 1 year.

In use, the device may be secured in the mouth of a subject, whereby the saliva of the subject moves through the pores of the delivery member, interacts with, e.g., dissolves, the medicament housed within the delivery member, and the resultant solution of saliva and medicament moves in and out of the delivery member in concert with the mouth movements of the subject. The water in the subject's saliva may slowly dissolve the medicament housed within the delivery member, or other saliva components, such as enzymes, may degrade the medicament, or some combination of these mechanisms may occur. The medicament may be released or diffused into the mouth of the subject by, e.g., mastication, sucking, moisture, pH change, and the like.

The preceding detailed description has related but a few of many possible ways of configuring the device of the instant invention comprising at least one insertion member, and at least medicament member. For example, various features of the disclosure are grouped together in one or more aspects, embodiments, and configurations for the purpose of streamlining the disclosure and ease of understanding. Infinite variations of the medicament delivery device are possible, e.g., simply by changing delivery member(s), combining delivery members, changing insertion members, substituting sensors for delivery members, etc., and consequently would violate the spirit of this disclosure. The device may be used either alone or in combination with other medicament delivery systems, agents, and/or conveniences. One skilled in the art will readily recognize that the disclosed device, methods of manufacture, and methods of use thereof can be readily incorporated into one of the established formats for production or use of medicament delivery systems and the like that are well known in the art. The device has been described in detail for the purposes of clarity and understanding. One skilled in the art could make any number of embodiments and/or adjustments thereto based on elements such as size, construction material, weight, method of use, etc., without undue experimentation. It will be appreciated that certain changes and modifications may be practiced within the scope of this disclosure. Accordingly it is intended that all such alteration, variations, and modification are within the scope of the present disclosure.

We claim:

1. An oral medicament delivery device adapted for insertion into the embrasure of a subject, comprising:
at least one insertion member; and
at least one delivery member.

2. The oral medicament delivery device according to claim 1, further comprising at least one connecting member.

3. The oral medicament delivery device according to claim 2, wherein the at least one delivery member comprises a biodegradable medicament.

4. The oral medicament delivery device according to claim 2, wherein the at least one delivery member comprises a non-biodegradable medicament housing.

5. The oral medicament delivery device according to claim 2, wherein the, at least one delivery member comprises a sensor.

6. The oral medicament delivery device according to claim 3, wherein the insertion member comprises an elongated compressible shaft adapted for insertion into the embrasure of a subject.

7. The oral medicament delivery device according to claim 4, wherein the insertion member comprises an elongated compressible shaft adapted for insertion into the embrasure of a subject.

8. The oral medicament delivery device according to claim 5, wherein the insertion member comprised an elongated compressible shaft adapted for insertion into the embrasure of a subject.

9. The oral medicament delivery device according to claim 1, wherein the insertion member comprises a slender shaft haying a tapered first end and broadened second and opposite end, and the first end optionally having an overlay.

10. The oral medicament delivery device according to claim 9, wherein the delivery member comprises a non-biodegradable, porous medicament housing,

11. The oral medicament delivery device according to claim 9, wherein the delivery member comprises a non-biodegradable, non-porous medicament housing.

12. The oral medicament delivery device according to claim 10, wherein the delivery member comprises a non-biodegradable, porous medicament housing, and a slender shaft having a tapered first end and broadened second and opposite second end, the first end optionally having an overlay.

13. The oral medicament delivery device according to claim 10, wherein the delivery member comprises a non-biodegradable, porous medicament housing having at least one aperture there through.

14. An oral medicament delivery device adapted for insertion into the embrasure of a subject, comprising:
at least one insertion member, the insertion member comprising a slender shaft having a tapered first end and a broadened second and opposite end, the first end optionally having an foam overlay and
at least one delivery member, wherein the at least one delivery member comprises a non-biodegradable, porous medicament housing.

15. A method for passive oral administration of medicament to a subject in need thereof, the method comprising: immobilizing a medicament delivery device into embrasure of the subject, wherein the device comprises at least one insertion member and at least one delivery member.

16. The method according to claim 15, wherein the at least one insertion member comprises an elongated compressible shaft adapted for insertion into embrasure or a slender shaft having a tapered first end and broadened second and opposite end, the first end optionally having an overlay.

17. The method according to claim 15, wherein in the at least one delivery member comprises a biodegradable medicament or a non-biodegradable medicament housing.
